(19) United States
(12) Patent Application Publication
(10) Pub. No.: US 2022/0149697 A1
(43) Pub. Date: May 12, 2022

(54) AUTOMATIC WINS AND PHOTOVOLTAIC ENERGY STORAGE SYSTEM FOR UNINTERRUPTED ELECTRICITY GENERATION AND ENERGY AUTONOMY

(71) Applicant: Nicholas Pan. Pittas, Rion Achaia (GR)

(72) Inventor: Nicholas Pan. Pittas, Rion Achaia (GR)

(21) Appl. No.: 17/415,732

(22) PCT Filed: Dec. 17, 2019
(86) PCT No.: PCT/GR2019/000090

§ 371 Date: Jun. 18, 2021

(30) Foreign Application Priority Data
Dec. 18, 2018 (GR) 20180100563

(51) Int. Cl. H02K 7/18; H02J 15/00; H02J 3/38; F03D 9/00; F03D 9/11; F01K 21/00

(52) U.S. Cl. CPC H02K 7/183; H02J 15/006; H02J 3/381; F03D 9/007; F05B 2220/706; F01K 21/00; H02J 2300/24; H02J 2300/28; F05B 2220/708; F03D 9/11

(57) ABSTRACT

Automatic wind and photovoltaic energy storage system for generation of uninterrupted electricity and energy autonomy, characterized in that it consists of wind machines (A) and photovoltaic generators (B) combined or independent which operate mechanically or electrically connected suitable compressors (Γ1, Γ2, Γ3, Γ4) that compress air at high pressure while simultaneously removing the heat generated by compression with small heat exchangers (E1, E2, E3, E4), by heating diathermic cooling oil and water stored in separate insulated tanks (H1, H2, H3, Z2) they drive it to an airtight tank-serpentine coil type tank (M), where it exits and after passing through the air flow distributor in each group of high pressure crosses the groups of heat exchangers (θ1) in which the flow flows backwards cooling oil, where its thermal charge is transferred and heats the compressed air before entering the gas turbine and expands to a certain pressure lower and temperature lower the original T2. At this point the compressed air flows coming out of the turbine and reheats in the same way as in the first re-heat, that is, by crossing another set of heat exchangers (02) similar to the first one, but at a lower pressure and re-introducing at the same pressure it exited but at the same temperature as the original Ti. To expanding again to a given pressure corresponding to the next stage according to the thermodynamic analysis. The expansion continues with the intermediate reheats according to the specified stages of the thermodynamic analysis, until after the last reheat in the last stage, inject the quantity of water vapor (steam) stored in a separate insulated tank (Z2) into the flow of compressed air expanding the common fluid (compressed air plus steam) at the same pressure and temperature into the turbine (K), achieving approximately a 20% increase in the overall turbine (K) efficiency. The turbine is equipped, by means of a rotary shaft rotary controller, to be able to modulate the supply of compressed air to the turbine head (K). And since the mass flow rate of compressed air is directly proportional to the electricity produced, the generation of electricity produced is identical to the demand Automatic wind and photovoltaic energy storage system for generation of uninterrupted electricity and energy autonomy, characterized in that it consists of wind machines (A) and photovoltaic generators (B) combined or independent which operate mechanically or electrically connected suitable compressors (IT, Γ2,Γ3,Γ4) that compress air at high pressure while simultaneously removing the heat generated by compression with small heat exchangers (E1, E2, E3, E4), by heating diathermic cooling oil and water stored in separate insulated tanks (H1, H2, H3, Z2) they drive it to an airtight tank-serpentine coil type tank (M), where it exits and after passing through the air flow distributor in each group of high pressure crosses the groups of heat exchangers (θ1) in which the flow flows backwards cooling oil, where its thermal charge is transferred and heats the compressed air before entering the gas turbine and expands to a certain pressure lower and temperature lower the original T2. At this point the compressed air flows coming out of the turbine and reheats in the same way as in the first re-heat, that is, by crossing another set of heat exchangers (02) similar to the first one, but at a lower pressure and re-introducing at the same pressure it exited but at the same temperature as the original T1. To expanding again to a given pressure corresponding to the next stage according to the thermodynamic analysis. The expansion continues with the intermediate reheats according to the specified stages of the thermodynamic analysis, until after the last reheat in the last stage, inject the quantity of water vapor (steam) stored in a separate insulated tank (Z2) into the flow of compressed air expanding the common fluid (compressed air plus steam) at the same pressure and temperature into the turbine (K), achieving approximately a 20% increase in the overall turbine (K) efficiency. The turbine is equipped, by means of a rotary shaft rotary controller, to be able to modulate the supply of compressed air to the turbine head (K). And since the mass flow rate of compressed air is directly proportional to the electricity produced, the generation of electricity produced is identical to the demand since its axis of rotation is connected to the axis of the generator at the terminals of which the electricity is generated and the heat air generated exits will be used for district heating.

### FIELD OF THE INVENTION

In the application for my patent NO 1008370, I presented an innovative electricity storage and generation system, supplied by wind energy and photovoltaic energy systems either in combination or separately, and the option to use said energy is decided on the basis of the wind and photovoltaic potential offered on-site.

### BACKGROUND OF THE INVENTION

That the construction of storage tanks with large geometric volume and weight is difficult to implement, since it is hard to roll 90 mm sheet metal to a cylinder, while the huge weight of the tanks make them hard to transfer, plus the fact that they are very costly. For this reason, these are replaced by a coil type serpentine, namely welded pipes of appropriate thickness, i.e. 15-35 mm—preferably 25 mm, with on internal diameter of 200-700 mm—preferably 508 mm. Every 4,938 m of this pipe correspond to Im3 of geometric volume. Therefore, any geometric volume required for the storage of compressed air within the range form 170-250 bar—preferably 200 bar—can be created by transferring these pipes at the facility site, welding them to each other and placing them on the surface of the site available. The thickness of 25 mm guarantees for structural strength against an internal pressure of up to 320 bar, although the operating pressure of the unit will be much smaller. Furthermore, for safety reasons, it is imperative that the electrical welding is checked with ultrasounds, X rays, extensive and prolonged hydraulic pressure and certified by accredited institutions.

### SUMMARY OF THE INVENTION

That the air compressors to be used are of advanced technology and perform two functions at the same time:
1) They will compress atmospheric air, indicatively at 200 bar or more if necessary, and at the same time.
2) The compression-generated heat will be transferred to a cooling fluid, which can be either water or something else, such as refrigeration oil, via thermal exchangers that will intervene for each compression stage of each individual air compressor.

### BRIEF DESCRIPTION OF THE DRAWINGS

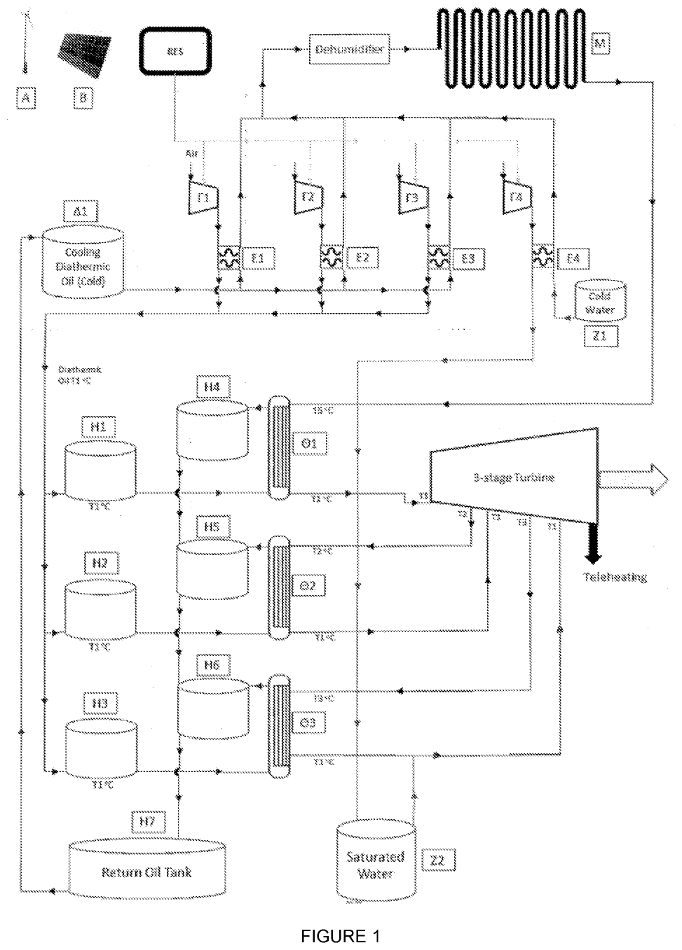

Brief reference to FIG. 1, showing the primary energy sources, wind turbine (A) and photovoltaic panels (B) the dehumidifier, the compressed air serpentine-coil tank (M), the air compressors Gᵢ, T₂, IT, G₄ accompanied by the corresponding thermal exchangers Eᵢ E₂ E₃ E₄ for the dissipation of the heat generated by compression, the heat-insulated storage tank for refrigeration oil Hi, EE, 3/4, 3/4, 3/4, He, H₇ and Di and the corresponding tanks for saturated water Zi, Z₂, as well as the thermal exchangers 0₁ 0₂, 0₃, the turbine K with the generator connected to it.

### DETAILED DESCRIPTION OF THE PREFERRED EMBODIMENTS

It is obvious that compression from 1 bar to 200 bar will require a number of stages and cannot be implemented directly within a single stage, as this would melt the cylinder and piston due to the excessive generated heat, as the final air temperature will be of an order of 1032° C. Water can be an excellent carrier-heat sink of the generated heat per compression stage of each individual air compressor due to its high thermal capacity, which is equal to cp=4.18 kcal/kg ° C., but in these temperatures the phase changes (evaporation) demand advanced operational safety procedures, as well as high cost for the necessary equipment. We therefore choose the largest number of air compressors to use refrigeration oil and the smallest number of air compressors to use water, to a rate of e.g. 4/1.

The reason for this choice will be explained below.

The generation of high temperature oil and saturated water is the result of the intercooling process implemented on the compressed air in between the compressor stages. The generated quantities of the two cooling fluids are to be stored within separate insulated tanks while the compressed air is to be stored on the larger, high pressure (200 bars) tank made from serpentine coils, as described earlier. Each cubic meter of compressed air on expanding through a proper turbine (of reheated stages) from the high pressure (200 bars) down to the atmospheric one will generate about 30 kwh of electric energy.

Large volume tanks are required so that the energy storage capacity in MWh will be enough to satisfy the energy requirements of the nearby community for a reasonable length of time.

This innovative energy storage scheme employs high-pressure air compressors, each of which employs a number of intermediate stages, allowing for a regulated intercooling of the compressed air, so that the exit temperature of the air is maintained low, permitting the storage of a higher air mass inside the tank.

The optimum selection of the intercooling stages will depend on the exit temperature of the cooling fluids from each stage. For example, compressing in one stage atmospheric air initially at 20° C. up to a pressure level of 60 bars, it means that the exit temperature of the air will have reached a level of about 270° C.

The countercurrent heat exchanger will bring the exit temperature of the cooling fluid (water or oil) to a similar temperature, while the compressed air will be cooled back to a temperature near the original.

The process will be repeated in all compression stages downstream, so that at the exit of the compressor the air will have reached a pressure of 200 bars but the temperature will not be much above the atmospheric (i.e. around 20° C.).

The heated masses of the cooling fluids will be stored inside insulated tanks, ready for the reheating processes during the expansion of the stored air inside the air turbines that will drive the electric generators, resupplying the community at times of need. This method will generate about 210.6 kg/h of saturated water by each compressor driven by a 73 kW electric motor to be supplied with electric energy by the Aeolic/solar plants, enough to compress 280 Nm3/h of ambient air up to 200 bar generating 434.4 kg/h of cooling oil. The difference between the generated flow rates among the two cooling fluids is due to the lower cp=2.18 kcal/kg ° C. of the cooling oil compared to a cp=4.18 kcal/kg ° C. for the water.

The number of the compressor units will be selected after an optimization analysis between the long hours needed to fill the storage air tank and the resupply of the surrounding community.

The time needed to fill the tank can be reduced by increasing the number of compressors. When we employ 5 compressors absorbing 73 kw of electric power for the filling of a storage tank of volume 600 m3, each of them will be able to deliver to the tank compressed air at a rate of 280 Nm3/h and a pressure of 200 bars.

Since lm at 200 bar occupies 51 t in volume, 280 Nm/h will occupy a volume of 5×280=1400 lt. Hence the 5 air compressors together will fill a volume equal to 1400×5=7000 lt. Since the total volume of the serpentine tank is 600 m3 this means that it will take 6000001 t/7000 lt/h=85.7 h to fill the serpentine tank. In addition, during this period the intercooling heat exchangers will generate 85.7×434.4×4=146.920 0.8 kg of heated cooling oil at a temperature between 180-270° C. that will be stored in the insulated tanks designated for this oil. At a later stage this hot oil will drive the reheating process in the turbine stages.

In addition, the intercooling process will generate saturated water at a rate of 85.7×210.6=18.048.4 kg of saturated water at a temperature within the same range (180-270° C.) and stored inside a similar insulated tank. It will take 5 insulated tanks of a capacity of 80 m3 each for the storage of the hot oil if the number of the reheating stages is 5. To this one needs to add a similar number of 5 return tanks of a 80_m3 capacity for the“cooled” oil. The fully cooled oil will be driven from these 5 tanks into a larger 5×80=400 m3 tank that will supply the intercooling processes, repeating the cycle. In total 5+5+1=11 tanks will be required for the cooling oil and 1 tank for the saturated water. In other words, 12 storage tanks will be needed for the entire plant.

These tanks must be constructed with an insulating cover that will ensure the maintenance of the initial temperature (180-270° C.) for a sufficient time. The reason we are trying to recover waste heat, is based on the fact that in conventional air compressors only 20-22% of the energy consumed is converted into pressure energy. The remaining 70-78% is lost to the environment in the form of heat dissipation. This loss tends to become greater than 75-78% as we compress the air into greater pressures.

The heating of the compressed air forces a parallel dilatation due to the temperature rise, so that it requires additional energy to be spent on the compression process.

The stored diathermic oil at a temperature of 190-270° C. will be able to reheat the air as it travels from the large storage tank into the turbine for the conversion of the stored air pressure energy into electricity.

The storage of the heated oil and the subsequent reheating of the stored air as it passes through the turbine stages eliminates any possibility of freezing of the humidity content within the stored air, thus avoiding any flow blockage inside the turbine passages.

The method is to be implemented as follows. The large tank supplies with stored compressed air a tubular header of a proper length and diameter. Transversely to the header axis, the compressed air is distributed to several straight shell and tube heat exchangers that reheat the compressed air by heat supplied by the stored hot oil.

The air tubes inside these heat exchangers are of a small diameter (of the order of 19 mm, with a wall thickness of about 24 mm that guarantees enough strength against the high air pressure). These small diameter tubes are of about 8-9 meters in length and connected on the opposite end to another (receiving) header that supplies the turbine head. The outer diameter of the shell will be of the order of about 800-900 mm, and it's exhaust header will supply the turbine head with air of a temperature of the order of 190-270° C. while the hot oil will transverse the heat exchanger in the opposite direction. Such a turbine will generate electric power of the order of 1 MW in the above configuration.

The now cooled oil from the shell and tube heat exchangers will be driven to the return storage tank. This description defines the heat exchange process between the compressed air and the cooling oil. This is required because the compressed air is stored at nearly atmospheric temperatures and has the tendency for its humidity content to freeze even under small expansion ratios.

It is obvious that a large expansion ratio (from 200 bars down to the atmospheric one) requires a fairly large number of intermediate reheating processes, i.e. increased number of heat exchangers, which will also be in series. The heat exchange time between cold compressed air and hot diathermic oil is 1 sec. The lower temperature diathermic oil exiting the heat exchangers enters the lower temperature diathermic oil return storage tank.

The thermodynamic analysis of the energy storage and power system showed that in order to avoid ice formation during the air expansion inside the turbine, the compressed air in the turbine should be reheated in several stages in order to 1) eliminate the possibility of ice formation and 2) increase the thermodynamic efficiency of the unit.

To achieve this, we select the following procedure from the thermodynamic analysis for a 5-step expansion and thus (for example) produce 5 MW. For such a power output the steps are defined as follows: (200-110 bar) the first stage, (110-60 bar) the second, (60-28 bar) the third, (28-13 bar) the fourth and (13-1.5 bar) the final (fifth) stage. It is obvious that the pressures per step will change for each given turbine, while the compressed air will be cooler after each expansion stage.

This air will be reheated by the system of heat exchangers powered by the hot diathermic oil from the second heat insulated tank maintained at a temperature of 190-270° C. so that in the second turbine stage the compressed air will re-enter the turbine at 110 bar but at a temperature near to the 190-270° C. range. Behind the first turbine stage the expansion process will lead to an exit pressure of 60 bars and a temperature around 155° C. The next reheating stage will employ high temperature oil at 190-270° C. from the third insulated tank and will bring the compressed air back to the initial temperature of 190-270° C. and re-inserted inside the turbine at nearly 60 bar and exit at a pressure of 28 bars. The next stage will employ oil from the fourth insulated tank. The next stage will expand and cool down to 13 bar and to come out and reheat to the original high temperature of 190-270° C. with the heat exchangers from the fifth insulated tank. Then it will expand again from 13 bar to 1.5 bar. It is evident that in each reheating stage there is also a corresponding heat insulated return tank for the lower temperature oil.

It is apparent that the reheating heat exchangers will be designed according to the different temperature and pressure parameters determined by the thermodynamic analysis.

The heat insulated tanks will maintain one high temperature for the diathermic oil and another (lower) one for returning diathermic after it passes through the heat exchangers, where it has passed to the compressed air its proper thermal load.

The lower heat thermally insulated tanks are connected to each other and their content ends up inside the cold diathermic oil tank, which in turn supplies the intercooling heat exchangers for each compression stage.

This oil supply is directed to each of the compressors to subtract the produced heat so as to complete the heat subtraction cycle from the air-compressors and subsequently is fed into the higher heat tanks to heat up the air supply from the serpentine air reservoir.

Because the reheating process with all accompanying equipment is very costly, there must be a compromise on the choice of the number of stages and the certainty of avoiding ice formation when the compressed air is expanded. The circulation of the diathermic cooling oil within the above circuit, for the entire storage and power plant to be self-sufficient, will be implemented by employing compressed air as the driving force.

The latter will be stored inside a tank of appropriate volume, and pressure of around 30 bar, which is supplied by the large serpentine tank. When the air pressure inside the latter reaches 30 bar the air supply will be interrupted from it.

From this tank begins a pneumatic circuit that drives small rotor-impeller motors. In the extension of the axes of these rotors are connected the pumps which push the diathermic oil through the heat exchangers.

In order to illustrate the operation of this subsystem when the plant delivers 1 MW, the flux of diathermic oil required will be approximately 4 tonnes per hour, while a generation of 5 MW will require 18 tonnes to be circulated.

Next the operation of the water cooling network will be discussed during the intercooling of the compressed air. This network will supplement the air-compressors in a proportion of 4 to 1 diathermic oil and water. The operation of these few air compressors is similar to those of the corresponding air compressors using diathermic cooling oil. However, the volume of saturated water formed is stored in separate insulated, suitable tanks.

The corresponding thermodynamic analysis deduces that intercooling will generate 0.132 kg of saturated water per kg of air compressed from an atmospheric pressure up to 200 bar.

This is to mean that more energy was spent than that which was obtained from the turbine expansion process. With this excess energy we can heat a volume of water gaining from the increase of the compressed air expansion in the turbine,

This results in a mass of saturated water, i.e. steam at temperatures above 190° C. and a pressure of 14 bar or higher.

From the saturated water data, it becomes clear that the water saturation pressure, that corresponds to the maximum compressed air temperature of 270° C., is about 60 bars, according to the Mollier diagram.

This saturated water will be injected into the expanding air inside a turbine stage, so that by increasing the expanding fluid (i.e. humid air) mass flux will lead to the generation of a greater power output of electricity. At the lower air pressure at the point of injection the saturated water will evaporate into steam to a large extend. The rest of the water will evaporate into humidity inside the dry air, as the latter expands inside the turbine. The water injection will be regulated so that at the turbine exit the humid air is above the dew point for the exhaust temperature of conditions at the pressure of the surrounding atmosphere.

Since the final pressure of expansion of the mixture is atmospheric pressure and the temperature is around 35° C. it corresponds to the value of enthalpy hi=612 kcal/kg ° C. and the initial value of the steam enthalpy before the mixing equals l12 which corresponds to 668 kcal/kg ° C. The enthalpy difference Ah=li2−hi will be in the range from 70 to 200 kcal/kg ° C., depending on the temperature of the steam and on the level of development of the compressor unit.

Since the power output is given by the expression P=M×Ah×nt/860 where M is the mass of steam, nt the turbine performance and Ah is the difference in enthalpy. If we consider the turbine yield (efficiency) to be close to 0.86, as is usually the case, then the generated power will be expressed as P=M×Ah/1000. It is also reasonable that by increasing the mass of the gas mixture (compressed air with steam) and in particular the mass of the steam produced as excess energy (which is stored in the form of steam by compression) we increase the power finally produced. This mass of steam arises from the air compressors during the compression process and multiplied by the enthalpy difference represents the excess energy that was consumed during compression. In this way an overall increase in turbine power by 40% can be achieved. Most significantly apart from an efficient control of the thermodynamic cycle we also achieve an all-important stabilization of the produced power despite the occurrence of pressure drop in the serpentine tank.

This power enhancement will be increased even further if the saturated water is overheated by the addition to the plant of proper solar collectors that may increase the water temperature in the order of 300-350° C.

So, if the turbine expands the compressed air in 5 stages with intermediate reheats per stage for a supply of 25,000 Nm3/h and initial values of P=200 bar, T=250° C., it will generate a power output of 4.4 MW electric.

If we inject the excess water at a rate 0.132 kg of steam/kg air×25000 Nm3 air×1.2 kg (air)/Nm3 (air)=3960 kg of water/h and this evaporates fully, as explained above, this will result into a power output increase of IMW. That is, the total power produced will reach 5.4 MW. In other words, the implementation of this concept will result into a 40% increase in total power generation capacity. This method is unique and has not been proposed anywhere in the world.

The operation of this system is described in the following.

The electricity generated from the A/G (Wind Turbine) (A), in combination with the electricity supply by the PV (Photo Voltaic) generators (B) gradually and sequentially compresses atmospheric air in the compressors (Ti), (G2), (G3), (G4) which achieve a compression of the ambient air up to about 180-250 bar, and preferably closer to 200 bar, and then pump it into the airtight serpentine coil tank (M).

This compressed air is directed to the expansion turbines by passing first through the heat exchanger system (Qi) and reheated by the heat accumulated through the diathermic oil at a temperature Ti=(190-270) ° C. inside the insulated tank (Hi). The air enters the turbine and after expanding inside the first stage exits at a lower temperature T2 and is reheated to the initial temperature Ti, so that it re-enters the next turbine stage at the same exit pressure and so on in the following stages. In front of the final stage it is reheated again up to temperature Ti. After the reheating process, saturated water from the insulated tank (Z2), supplied by water that intercooled the compressed air, will be injected into the air flow and mix with the reheated compressed air with steam at the same pressure and temperature so that the mixture can be expanded to 35° C. at 1.5 bar.

The final exhaust of the humid air from the turbine (that is appropriately clean for any subsequent use) will be exploited for district heating. The shaft of the turbine (K) is connected to a generator at the terminals of which the electricity will be generated.

The 170-250 bars for the serpentine tank, as well as the attainment of temperatures of 190-270° C. for the diathermic cooling oil or the saturated water resulting from the intercooling operation of the high pressure compressors, do not represent a maximum operating limit but are a practical (currently feasible state of the art) design operation level.

And these technical specifications will be readily adaptable over time based on the evolution of e.g. material science (e.g. graphene) with regard to the serpentine high pressure tank, so that these can be manufactured at a lower cost with a larger volume serpentine-tank at higher pressures, aspects that will increase the energy density of the compressed air and ultimately will increase the electrical energy autonomy, while at the same time will allow higher operating temperatures that will further improve the overall thermodynamic efficiency of the unit.

The selection of the peak operating pressure in the high-pressure storage tank is the critical parameter for the achievement of the high energy density necessary to obtain energy autonomy with a relatively limited geometric volume and correspondingly reduced cost.

Although such a tank may have been manufactured for different applications it has never been constructed targeting the above mentioned technical characteristics and specifications and particularly so into the formation of a single stage serpentine tank for highly compressed air storage and subsequent generation of electricity. The serpentine tank (M) is suitably shaped and dimensionalized for storing compressed air to greatly exceed energy requirements (many cubic meters of air stored at e.g. 200 bar, which is energetically equivalent to many MWh stored) during the most typical insufficient wind or sunshine time periods according to local meteorological data.

The operation of the device is as follows. We activate on/off the NG (A) as well as the photovoltaic generators (B) which operate the compressors (IT), (G2), (GT), (G) with the electricity they provide to a common power line, in a scalable and sequential fashion due to the high requirements in electricity load at startup. This can be performed either from the electricity generated by the NG or the photovoltaic generator (B), or in combination from both sources, as illustrated in FIG. 1), where compressor units (IT), (IT), (G3), (IT) compress air to the design high compression ratio target and deliver it into the airtight serpentine tank (M), which is conducive to the reduction of the size of the tanks for a specific power autonomy.

To fill the tank e.g. with 600 of by a system of 4 compressors of 73 kw power each we can compress and give 280 Nm3/h at 200 bar i.e. and then deliver it to the serpentine tank (M) 280 Nm3/h×51 t/m3=14001 t/h and so 4 air compressors will deliver a total of 4×1400=56001 t/h and since the volume of the serpentine tank is 600 Nm3=600.000 1 t it means that 60000/5600=107.14 h will be required. And so it will take 107.14 hours of compressor operation time.

At the same time since each compressor produces/h simultaneous diathermic cooling oil 434.4 kg/h or 210.6 kg/h water saturated, they will have been produced by the operation of the three compressors 107×3×434.4=139.442.4 kg diathermic cooling oil at temperature Tj to be stored in the high temperature insulated tanks Hi 1 i2, H3, and further three backups plus 107×210.6=22.534.2 kg of saturated water (steam) will be stored in the heat insulated tank (Z2) at a temperature Ti.

By filling the serpentine tank, we activate the compressed air from the serpentine tank to the group of heat exchangers Qi, which in counter-flow to the diathermic oil flows through at the maximum temperature Ti, originating from the Hi insulated tank. And this tank transfers its heat load to the compressed air, which enters the gas turbine head (K) at a pressure of e.g. 200 bar and temperature Ti. The expansion is carried out until the pressure reaches the pressure value at the end of the first stage expansion as determined by the thermodynamic analysis and the corresponding lower temperature equal to T2. At the end of this the total flow exits the turbine to reheat from temperature T2 to Ti with T2<Ti and again be driven into the turbine at the same outlet pressure but reheated to the maximum temperature T1.

It then expands again until the pressure becomes equal to that at the end of the second stage expansion and of course at a temperature T3 lower as T3<T2<Ti. As the total flow rate of the compressed air re-exits from the turbine (K) it is reheated up to the maximum temperature Ti, crossing the group of heat exchangers (Q3) in counter-flow from that to the diathermic oil exiting the insulated tank 3/4.

Then it is driven again for expansion by returning to the turbine at the same pressure but at maximum temperature Ti, but before it enters it is mixed and drawn by the steam stored in the insulated tank (Z2) at about the same pressure and maximum temperature Ti, and the combined fluid mixture expands until to 1.5 bar and 38° C. This operation results in a 40% increase in the efficiency of the turbine (K), as shown by the calculations in the attached example. The diathermic cooling oil after transferring its heat load is then returned to the corresponding heat insulated tanks 3/4, T15, I k, H7 and returned to the tank (Di) again.

When the compressed air enters the turbine head, the turbine shaft (K) as well as the generator connected directly to the rotor shaft are set to rotation to generate electricity at its terminals.

With the exhaust air coming out of the turbine at the temperature e.g. about T=38° C., and a suitable pressure of 1.5 bar, district heating can also be realized. The temperature of the outlet air depends on the pressure we select to release it.

This makes the system run smoothly and reliably since it eliminates the possibility to create ice on the turbine blades resulting in a malfunction of the system.

FIG. 1) illustrates the basic structure of the plant layout for wind or photovoltaic power transformer or a combination of both RES, in electricity with uninterrupted power supply and energy autonomy.

And consequently when there is apnea or insufficient sunshine, from the compressed-air tank (M), compressed air is extracted and enters the turbine (K) after passing through groups of heat exchangers and is reheated, and this process is repeated at specified stages. The compressed air causes the turbine shaft (K) to rotate, rotating in turn the generator (6) connected to it producing electricity.

This compressed air storage process can be activated in a cyclic sequence at any time I is required by automatically starting the compressors from the electricity generated by the wind turbine (A) and the corresponding photovoltaic (B) generator and at the same time generate electricity from the generator connected with the axis of rotation of the turbine (K).

For complete automation and operation of the set up the whole system is accompanied by filters, gears, couplers, reducers, sensors, thermometers, presses, PLC's, inverters and more, whose electronic endpoints all end up in the layout of the control unit.

This plant provides uninterrupted electricity generation from these RES without intermittency based on wind speed or insufficient sunshine and becomes fully reliable as this device smoothes the changing load as it entails both operational and economic potential into the grid, which accrues due to the stochastic nature of RES.

In my patent application No 1008370 the following have been described.

As it is known, by compressing air it is heated and this heat must be removed to the environment so that the temperature remains constant. In practice to cool a compressor we supply an internal compact air/air heat exchanger in order to optimize the heat transfer of the liquid/air heat exchanger, to extract the heat produced by the compressors (liquid coolers) as waste and to heat the incoming compressed air into the turbine head, with the intent to increase enthalpy.

For isothermal compression perfect gases we have:

$$PV = nRT = const \\ X ]$$

$${W}_{ab} = {\int }_{a}^{b} P \cdot dV = {\int }_{a}^{b} n \cdot R \cdot T \frac{dV}{V} = n \cdot R \cdot T {\int }_{a}^{b} \frac{dV}{V} = n \cdot R \cdot T \cdot ( ln {V}_{b} - ln {V}_{a} = n \cdot R \cdot T \cdot ln ( \frac{{V}_{a}}{{V}_{b}} ) = n \cdot R \cdot T \cdot ln ( \frac{{P}_{a}}{{P}_{b}} ) = P \cdot V \cdot ln ( \frac{{P}_{a}}{{P}_{b}} )$$

where P is the absolute pressure, V is the volume of the tank, R is the universal gas constant, T is the absolute temperature, and W is the stored energy.

So we have about:

(p 3

2.27 ln ^{a}kJ at 0° o at 273,15° K or

V P_{b}

2.478 at 25° or 298° C. mole or

$$: ln ( \frac{{P}_{a}}{{P}_{b}} ) kJ$$

$$100$$

$$ln ( \frac{{P}_{a}}{{P}_{b}} ) kJ \text{/} {m}^{3}$$

In the submitted modification of this patent No 1008370 the method of construction, manufacturing and implementation are clearly set out.

A unit with very high compressed air storage capacity compared to another with limited storage capacity will produce more electricity. Large-scale energy storage in the form of compressed air can generate electricity for a long time without the wind, or enough sunshine and respond to load demand and achieve a matching power demand curve with that of supply.

The ability to operate a NG with simultaneous presence of PV for generate electricity increases the energy autonomy.

Since the power of the energy produced depends on the supply, because as it is known P (Kw)=M (Ah) s/860X n=M (Ah) s/1000 where nt=0.86 and M is the mass flow rate of compressed air and Ah the enthalpy difference. Depending on our requirements, we increase the supply of compressed mass air flow rate, to the turbine head so that the demand curve matches the supply curve.

Technically this is achieved with a rotation shaft controller so that we almost always have a frequency of 50 Hz as dictated by the needs of the grid and which operates a valve on the turbine head.

Thus, when load demand decreases, the speed controller instructs the valve to limit the mass flow rate of compressed air entering the turbine, and when demand increases with the same process the valve permits to increase mass flow rate, thereby increasing power.

This also results in increased energy autonomy offered by the device avoiding wasting more energy than the user needs.

The response time of converting compressed air and surging it into the grid with this system device is in the range of less than 10 to 15 secs, compared to approximately 1 hour for the hydroelectric units, 10 hours for thermoelectric generating sets (axial compressors, combustion chambers, gas turbines, generators), about 2 days for thermoelectric power plants and one week for nuclear power plants.

The rate of replenishment of the reservoir capacity (total capacity of airtight serpentine tanks) depends on the available wind-solar energy availability and therefore on the number and capacity of the wind-photovoltaic generators to capture it. The more wind-photovoltaic energy captured, the faster the energy of the reservoir is replenished.

One scenario of using this directional wind-photovoltaic energy system device is to reduce the unpredictable nature of a wind-photovoltaic park when the wind generators do not rotate or there is insufficient sunlight.

This directional device generates power with more reliability than high-efficiency photovoltaics can produce in their respective conventional wind farms with an accompanying improved utilization and transmission capacity. That is, a conventional 100 MW wind-photovoltaic park generates only a 30 to 40% power in contrast to our proposed layout that will produce 90-100 MW. In practice the present unit will store when the demand in electrical load is low and generate power when it will indeed be required.

It should also be noted that the system is conveniently modular, easily modifiable and adaptable and that, starting from a given power unit and storage capacity, one can add components in such an appropriate way so that it can address all future energy requirements that may arise.

Example of Energy Autonomy from Wind and PV Generators and Performance Rating of the Proposed Unit

We have power coming from either a photovoltaic generator or a PV or a combination of both sources at 900 kW total power level and have a volume capacity for compressed air storage equal to 600 m3.

Putting into operation e.g. 5 air compressors totaling a power of 5×73 kW=365 kW=0.365 MW which compress at 200 bar and introduce 280 Nm/h each i.e. 280×5=

1400 lt/h and for the five 5×1400=70001 t/h compressed air production from compressors. And therefore 600.000/7000=85.7 h are required to fill up the 600 m tank.

This means that the energy consumed equals 85.7×0.365=31.28 MWh.

On the other hand the energy to be produced in a turbine with input data P=200 bar, T=200-270° C. and over five expansion stages i.e. 200-34 bar, 34-11 bar, 11-1.1 bar equal to 1 MW.

Since the hourly consumption of compressed air by the turbine is 5000 Nm/h and the available volume to expand is 600×200=120000 m3, this means that the turbine will operate for 120,000/5000=24 h. That is to say, the generator will produce 24 MWh.

In addition, we will have the steam injected into the final stage of the expansion.

Saturated water (steam) output per hour will be 210.6 kg/h and so we will have an additional power to the turbine shaft equal to P as defined below.

Since the power of the energy produced depends on the mass flow rate, because it is known that P (Kw)=M (Ah) s/860X nt=M (Ah) s/1000 with nt=0.86 and M is the mass flow rate of the compressed air and Ah the enthalpy difference, we will have P=5000×1.2×0.132×70/1000=55.4 kw and multiplying it for 24 hours we will produce 1330.5 kw=1.330 MW, so the total power generated at the generator terminals is 24+1.33=25.330 MWh, i.e. total unit power yield is n=25.33/31.28=0.80.

It is obvious that the above unit can meet up to 1 MW maximum power requirements and significantly a 25 MWh total consumption.

To achieve energy autonomy with the above data it is essential for ensuring uninterrupted power supply security that our daily consumption should not exceed 3-4 MWh per day, so that we have a tank-replenishment time of at least 8 days, over which time period we are most likely to have sunshine or wind. If this is not the case, and this time period is not enough (depending on the wind and sunshine data of the place) we can increase the serpentine tank to the extent necessary for ensuring a sustainable energy autonomy.

1. Automatic wind and photovoltaic energy storage system for the generation of uninterrupted electricity and power supply, consisting of wind and photovoltaic generators combined or independent, starting its operation mechanically or electrically by connected compressors driven by the high pressure compressed air held in storage in suitable airtight tanks, after being dehydrated by almost total dehumidifier type filters. These tanks operate also as communicating vessels characterized by the fact that the above mentioned airtight tanks are of a coil type ie a single serpentine tank (M), consisting of common commercial tubes with a much smaller diameter (preferably 508 mm inner diameter and consequently much less thickness (preferably 25 mm for 200 bar), capable of safely resisting in high pressures (over 150 bar) preferably 200 bar, which will be welded locally and will cover the surface in parallel rows on the available surface for installation of the unit at an unparalleled low cost. Advanced compressors Gr G, G3, G4 compress atmospheric air at high pressures and pass it to the tank-serpentine (M) and at the same time the heat generated by compression is extracted from diathermic oil and water at temperature (160-270° C.) preferably the highest achievable through small heat exchangers Ei, E2, E3, E4 and stored in separate heat insulated tanks, derived from the use of an appropriate air compressors in proportionality 4/1, which extract the heat produced from the compression of air with diathermic oil-cooling and water and exiting them enters and expanding into the gas turbine (K), where the pressure is lowered to a specific pressure below the original eg 200 bar, as determined by the preceding thermodynamic analysis and exiting the turbine at a lower pressure and lower temperature T2 at the inlet, in the same way, by crossing the group of heat exchangers 02, such as the initial inlet temperature of the gas turbine head but at lower pressure and re-introduced at the same pressure but reheated at the same temperature (160-270° C.)=Ti preferably higher than the diathermic oil drain from the heat insulated tank LL. The number of reheats for each desired power is determined earlier by the thermodynamic analysis and in the last stage. before the final expansion stage implemented by reheating from the compressed air outlet temperature T3, to the temperature Ti from the insulated tank 3/4, crossing the group of heat exchangers ©3, and before entering the gas turbine (K). inject steam stored in the insulated tank (Z2) into the compressed air flow causing mixing in the direction of expansion of the common fluid (compressed air plus steam) into the turbine (K). This expansion at all stages will cause the turbine (K) to rotate and consequently rotate the generator connected to it generating electricity cumulatively from each stage plus along with the steam expansion stage at its electrical terminals. In addition, the outlet air since it is completely hygienic at a temperature of about 38° C. will be used for district heating. Forced flow in the thermo-hydraulic circuits of diathermic oil-cooling and water is ensured by means of a pneumatic tank charged through a branch of the serpentine tank at a pressure much lower than the 200 bars, i.e. a pressure of 6-15 bar and a smaller volume. The pneumatic circuit drives small impellers coupled to the elongated axis of the pump that supplies with oil and water the intercooling heat exchangers.

2. Automatic wind and photovoltaic energy storage system for the generation of uninterrupted electricity and energy autonomy according to claim 1, characterized in that the high compression achieved by the air compressors (1 i. G2,G3, G4) must be accompanied simultaneously and from a high temperature in the cooling fluid—i.e. cooling diathermic oil or water that subtract the heat generated by compression of the air inside the inserted small heat exchangers (Ei, E2, E3, E4), positioned between the compression stages; And this is achieved by the correct selection of the number of compression steps in the compressors resulting from prior thermodynamic analysis, to obtain the maximum temperature along with the compression so that it can be used as a high temperature heat source.

3. Automatic wind and photovoltaic energy storage system for generation of uninterrupted electricity and energy autonomy according to claim 1, characterized in that the diathermal cooling oil or the steam heated enters separate insulated tanks (Hi, 3/4,H3, Z2), to maintain the original temperature level for as long time as possible, until the compressors are switched on again feeding again with heat load the high temperature tanks.

4. Automatic wind and photovoltaic storage system for generation of uninterrupted electricity and energy autonomy according to claim 1, characterized in that the serpentine tank (M) ends up with a barrier at its end, Perpendicular to it and at an appropriate distance from its end and at appropriate distances are the necessary heat exchangers and a compressed air flow distributor is created, according to the capacity of the unit, so that the distributor of compressed air flow is perpendicular to the thermal exchangers required in T-shape;
And which can be mounted in parallel, as we have said, and as a continuation of each of them at their free end, before welding their ends in the compressed air flow direction with a similar geometrically and compressor-sized air collector.

5. An automatic wind and photovoltaic energy storage system for generation of uninterrupted electricity and energy autonomy according to claim 1 characterized in that the compressed air with maximum pressure passes through the heat exchanger or group of heat exchangers (Qi), to recover heat from the high temperature counter current flow of the diathermic-cooling oil, supplied by the high temperature (Hi) storage tank.

6. Automatic wind and photovoltaic energy storage system for generation of uninterrupted electricity and energy autonomy according to claim 1, characterized in that the thermal energy is transferred to the flow of compressed air at each stage through the heat exchanger groups (Qi, 02, Q3) and is supplied by the corresponding high temperature (Hi, 3/4, 3/4) storage tank. The diathermic cooling oil cools the compressed air inside the shell and tube heat exchangers by flowing in the counter current direction. The cooling oil forced flow is implemented through pumps that are pneumatically driven by smaller pneumatic storage tank.

7. Automatic wind and photovoltaic energy storage system for generation of uninterrupted electricity and energy autonomy according to claim 1, characterized in that the compressed air extracted out of the serpentine tank (M) through the flow distributor fixed on the end of this tank, enters the respective heat exchangers, recovers the heat load from the reverse flow of high temperature diathermic oil and ends up in the compressed air collector at maximum temperature T1 before entering of the turbine (K).

8. Automatic wind and photovoltaic energy storage system generation of uninterrupted electricity and energy autonomy according to claim 1 characterized by that the compressed air when exiting the heat exchanger collector enters the turbine (K). and expands down to a lower pressure and temperature, which is determined by the prior thermodynamic analysis which determines the subsequent expansion stages. Following this, the partially expanded air is reheated back to the temperature T 1 by the hot oil that was stored in his storage tank (after intercooling the compressor stages) in a second shell and tube heat exchanger. The process (i.e. partial expansion—reheating) is repeated in several stages till the compressed air exhausted.

9. Automatic wind and photovoltaic energy storage system for generation of uninterrupted electricity and energy autonomy according to claim 1 is characterized by the fact that compressed air must undergo reheating, at certain stages of expansion determined by prior thermodynamic analysis, in order to avoid the possibility of ice formation in the turbine blades (K) and consequently blocking and shutting down the unit.

10. Automatic wind and photovoltaic energy storage system for the production of uninterrupted electricity and energy autonomy according to claim 1 is characterized in that the compressed air at the last expansion stage and having previously been reheated to the maximum temperature T i itself with the initial, before entering the turbine for the last expansion, from the insulated tank (3/4), inject in the compressed air flow the stored steam from the insulated tank (Z2), where we keep the steam at the same pressure and temperature as the compressed air flow that pushed from steam, thereby mixing it with the compressed air flow and expanding the common fluid to the pressure about 1.1 bar at a temperature of 38° C. Achieving a turbine (K) thermodynamic efficiency increase by 40% of the total unit efficiency.

11. Automatic wind and photovoltaic energy storage system for generation of uninterrupted electricity and energy autonomy according to claim 1 is characterized in that the compressed air immediately after it enters the turbine (K) rotates the generator connected to the turbine rotation axis (K) and to the generator terminals generate electrical energy, such that
At each expansion stage we have a specific energy production and the total energy production is equal to the sum of the energy produced per stage, plus the percentage of energy corresponding to the discharge from the water vapor outflow to the last stage of the turbine (K).

12. Automatic wind and photovoltaic energy storage system for generation of uninterrupted electricity and energy autonomy according to claim 1 characterized in that the turbine shaft (K) is equipped with a speed controller and which operates a valve on the gas turbine head to modulate the desired power, so as to manage the introduction of the appropriate mass flow rate compressed air supply corresponding to the output of the desired power, so that the demand curve matches the supply curve.

13. Automatic wind and photovoltaic energy storage system for generation of uninterrupted electricity and energy autonomy according to claim 1 is characterized in that due to expansion the outlet compressed air is still hot at about 38° C. and can be used for district heating.

14. An automatic wind and photovoltaic energy storage system for the production of uninterrupted electricity and the supply of energy autonomy according to claim 1 is characterized in that the use made by this device is the storage and uninterrupted production of energy and consequently the provision of energy autonomy.

15. The method of storing wind and photovoltaic energy for uninterrupted power generation and energy autonomy is characterized by wind and/or photovoltaic generators driving air compressors (FI, G2, G3, G4). The air then is being compressed and the heat produced by the compression goes through oil driven heat exchangers and water saturators (Ei, E2, E3, E4). The heat exchangers heated diathermic cooling oil is then stored in separate insulated tanks (Hi, 3/4, EI3, Z2). The compressed air is driven into a gas-tight coil tank (M). When needed, the latter tank supplies the circuit with compressed air, which from the tank outlet pass through the group of heat exchangers (Qi), where the hot diathermic cooling oil flows in reverse, reheating along the way the compressed air before it enters the turbine to partially expand down a specified pressure and temperature (T2). Downstream of the heat exchanger, the compressed air passes through the second turbine stage and the associated second reheating heat exchanger (Q2). The reheating process is nearly isobaric and raises the compressed air temperature up to the initial oil temperature (Tj). The process is repeated until the final turbine stage is reached. Inside the head of the final turbine stage is injected the amount of saturated water. This water is being supplied by the insulated tank (Z2). After the saturated water mixes with the compressed air forming a humid air mixture which expands inside the turbine (K). This leads to an increased efficiency of the unit in addition to its functioning as a powerplant power regulator.
